(19) United States
(12) Patent Application Publication
(10) Pub. No.: US 2013/0215102 A1
(43) Pub. Date: Aug. 22, 2013

(54) DEVICE FOR DISPLAYING THREE-DIMENSIONAL IMAGES AND METHOD THEREOF

(71) Applicants: Chih-Yin Chiang, Nantou County (TW); Che-Wei Chang, Taoyuan County (TW)

(72) Inventors: Chih-Yin Chiang, Nantou County (TW); Che-Wei Chang, Taoyuan County (TW)

(21) Appl. No.: 13/443,895

(22) Filed: Apr. 11, 2012

(30) Foreign Application Priority Data
Feb. 22, 2012 (TW) 101105796

(51) Int. Cl. G06T 15/00

(52) U.S. Cl. 345/419

(57) ABSTRACT

A device for displaying three-dimensional images includes a processor, and a display panel. The processor is used for receiving a three-dimensional image signal, decoding the three-dimensional image signal to image data with a predetermined format, dividing the image data with the predetermined format into a plurality of parallel processing data groups, and executing image processing on the plurality of parallel processing data groups simultaneously. The display panel is used for displaying a three-dimensional image corresponding to the three-dimensional image signal according to image processing results of the plurality of parallel processing data groups.

### BACKGROUND OF THE INVENTION

1. Field of the Invention

The present invention relates to a device for displaying three-dimensional images and a method thereof, and particularly to a device for displaying three-dimensional images and a method thereof that can utilize multiple cores of a processor to execute image processing on a three-dimensional image signal simultaneously.

2. Description of the Prior Art

Please refer to FIG. 1. FIG. 1 is a flowchart illustrating an autostereoscopy three-dimensional image system playing three-dimensional images according to the prior art. As shown in FIG. 1, in Step 102, an original three-dimensional image signal is first decoded to generate three-dimensional image data corresponding to each frame. In Step 104, the three-dimensional image data are interweaved. That is to say, a left eye image of the three-dimensional image data and a right eye image of the three-dimensional image data corresponding to the same frame are interweaved with each other. Then, after the three-dimensional image data are interweaved, in Step 108, a display can display a three-dimensional image corresponding to the original three-dimensional image signal according to the three-dimensional image data which is interweaved.

Please refer to FIG. 2 and FIG. 3. FIG. 2 is a diagram illustrating utilizing a central processor 202 of the autostereoscopy three-dimensional image system to execute Step 102 and Step 104 in FIG. 1 according to the prior art, and FIG. 3 is a diagram illustrating utilizing a graphic processor 302 of the autostereoscopy three-dimensional image system to execute Step 102 in FIG. 1 and the central processor 202 to execute Step 104 in FIG. 1 according to the prior art. As shown in FIG. 2, when the central processor 202 executes Step 102 and Step 104 in FIG. 1, the central processor 202 may occupy most resources of the autostereoscopy three-dimensional image system. As shown in FIG. 3, when the graphic processor 302 executes Step 102 in FIG. 1 and the central processor 202 executes Step 104 in FIG. 1, although the graphic processor 302 utilizes less resources of the autostereoscopy three-dimensional image system compared to the central processor 202, the central processor 202 needs to execute Step 103 to copy an execution result in Step 102 (that is, frame data with a predetermined format) from a memory of a graphics card of the autostereoscopy three-dimensional image system to a main memory of the autostereoscopy three-dimensional image system before the central processor 202 executes Step 104. Thus, not only processing complexity of the autostereoscopy three-dimensional image system is increased, but also efficiency of the autostereoscopy three-dimensional image system is decreased.

### SUMMARY OF THE INVENTION

An embodiment provides a method for displaying three-dimensional images. The method includes receiving a three-dimensional image signal; decoding the three-dimensional image signal to image data with a predetermined format; dividing the image data with the predetermined format into a plurality of parallel processing data groups; executing image processing on the plurality of parallel processing data groups simultaneously; and displaying a three-dimensional image corresponding to the three-dimensional image signal according to image processing results of the plurality of parallel processing data groups.

Another embodiment provides a device for displaying three-dimensional images. The device provides a processor and a display panel. The processor is used for receiving a three-dimensional image signal, decoding the three-dimensional image signal to image data with a predetermined format, dividing the image data with the predetermined format into a plurality of parallel processing data groups, and executing image processing on the plurality of parallel processing data groups simultaneously. The display panel is used for displaying a three-dimensional image corresponding to the three-dimensional image signal according to image processing results of the plurality of parallel processing data groups.

The present invention provides a device for displaying three-dimensional images and a method for displaying three-dimensional images. The device and the method utilize a processor to decode a three-dimensional image signal to image data with a predetermined format, utilize the processor to divide the image data with the predetermined format into a plurality of parallel processing data groups, and utilize multiple cores of the processor to execute image processing on the plurality of parallel processing data groups simultaneously. Then, a display panel can display a three-dimensional image corresponding to the three-dimensional image signal according to image processing results of the plurality of parallel processing data groups. Compared to the prior art, because the present invention utilizes the multiple cores of the processor to execute the image processing on the plurality of parallel processing data groups simultaneously, the present invention does not occupy most resources of the device for displaying three-dimensional images.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating autostereoscopy three-dimensional image system playing three-dimensional images according to the prior art.

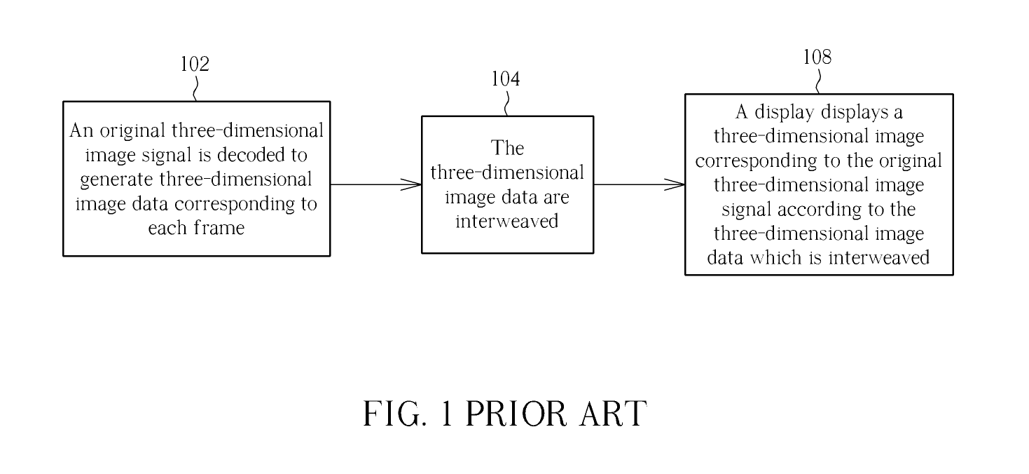

FIG. 2 is a diagram illustrating utilizing a central processor of the autostereoscopy three-dimensional image system to execute Step 102 and Step 104 in FIG. 1 according to the prior art.

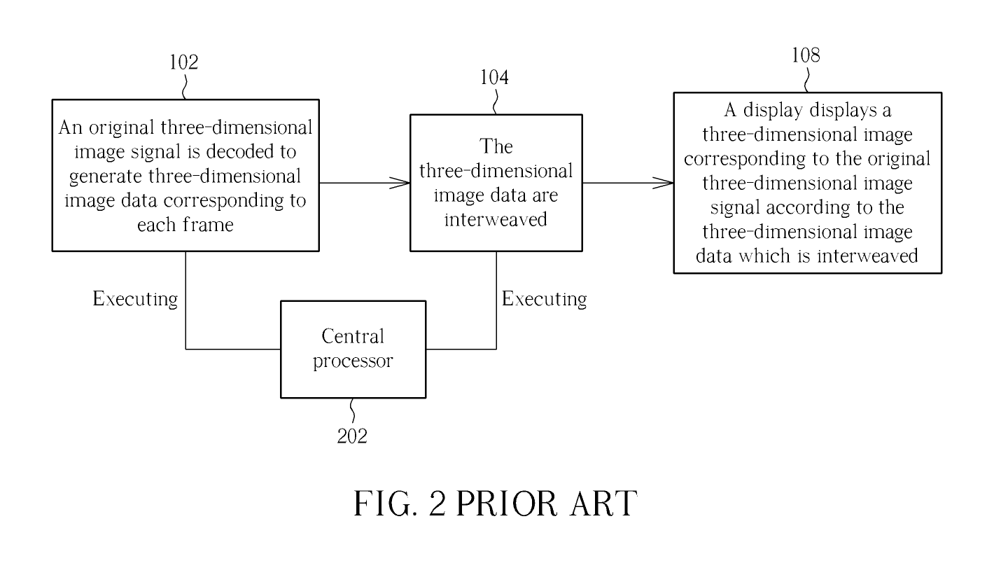

FIG. 3 is a diagram illustrating utilizing a graphic processor of the autostereoscopy three-dimensional image system to execute Step 102 in FIG. 1 and the central processor to execute Step 104 in FIG. 1 according to the prior art.

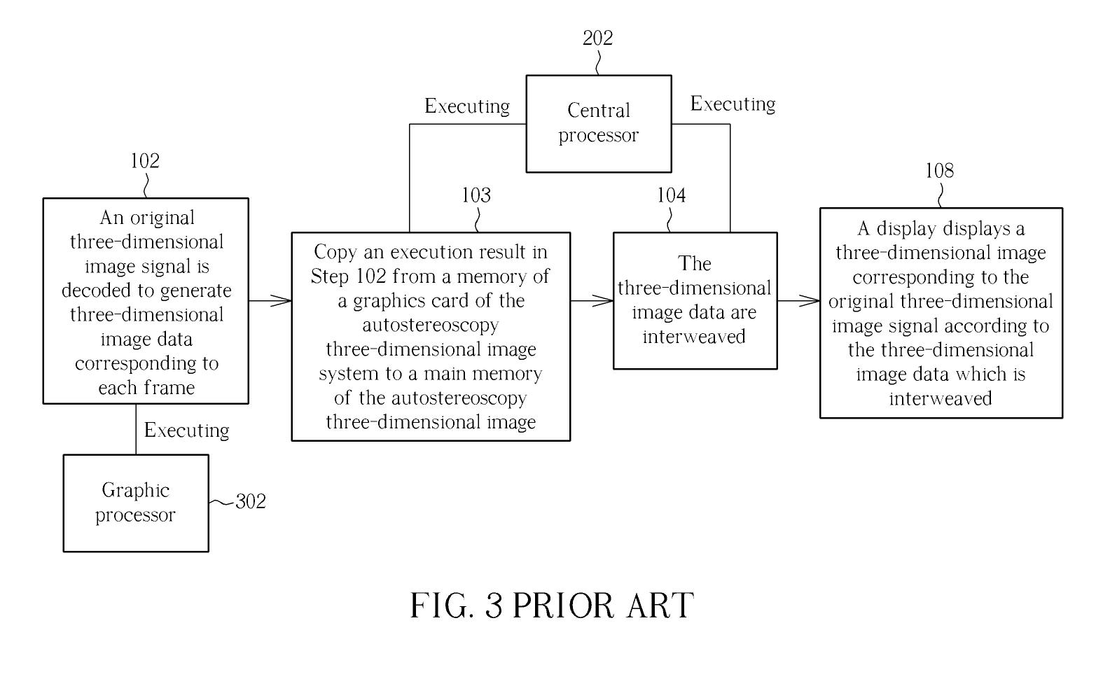

FIG. 4 is a diagram illustrating a device for displaying three-dimensional images according to an embodiment.

FIG. 5 is a diagram illustrating an image grid after the processor divides the image data with the predetermined format into the plurality of parallel processing data groups.

FIG. 6 is a diagram illustrating an image block including a plurality of execution threads.

FIG. 7 is a flowchart illustrating a method for displaying three-dimensional images according to another embodiment.

### DETAILED DESCRIPTION

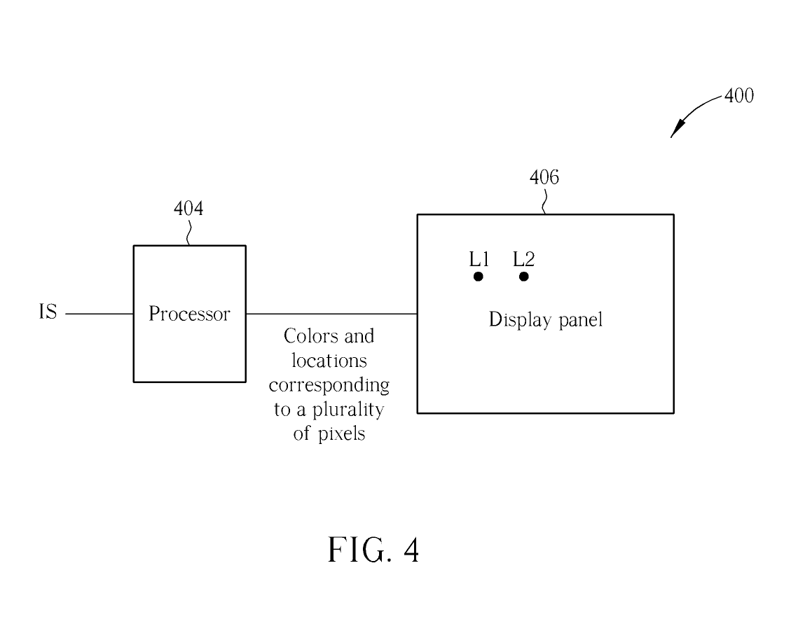

Please refer to FIG. 4. FIG. 4 is a diagram illustrating a device 400 for displaying three-dimensional images according to an embodiment. As shown in FIG. 4, the device 400 includes a processor 404 and a display panel 406. The processor 404 is used for receiving a three-dimensional image signal IS, and decoding the three-dimensional image signal IS to image data with a predetermined format. The predetermined format can be an NV12 format, and the processor 404 can be a graphic processor. But, the present invention is not limited to the predetermined format being the NV12 format, and the processor 404 being the graphic processor. Then, the processor 404 divides the image data with the predetermined format into a plurality of parallel processing data groups, and executes image processing on the plurality of parallel processing data groups simultaneously. The display panel 406 is used for displaying a three-dimensional image corresponding to the three-dimensional image signal IS according to image processing results of the plurality of parallel processing data groups . The display panel 406 can be a Liquid Crystal Retarder three-dimensional (LC Retarder 3D) panel or an autostereoscopy three-dimensional panel.

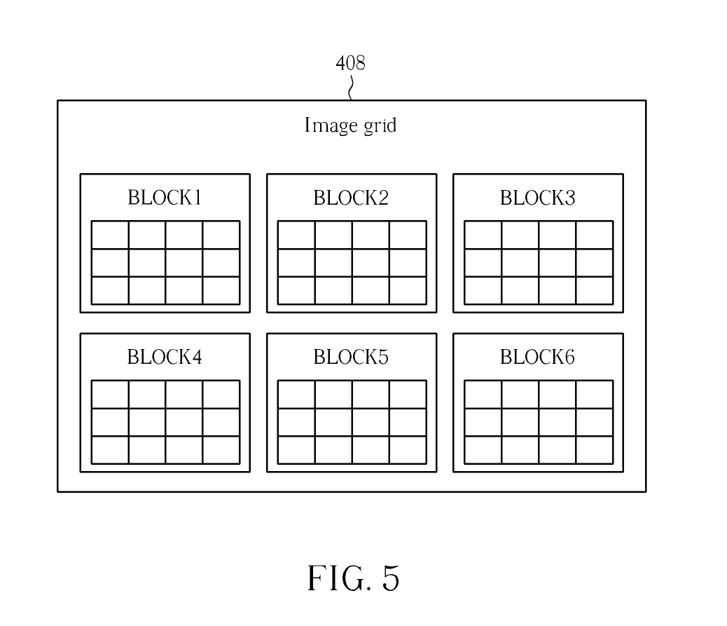

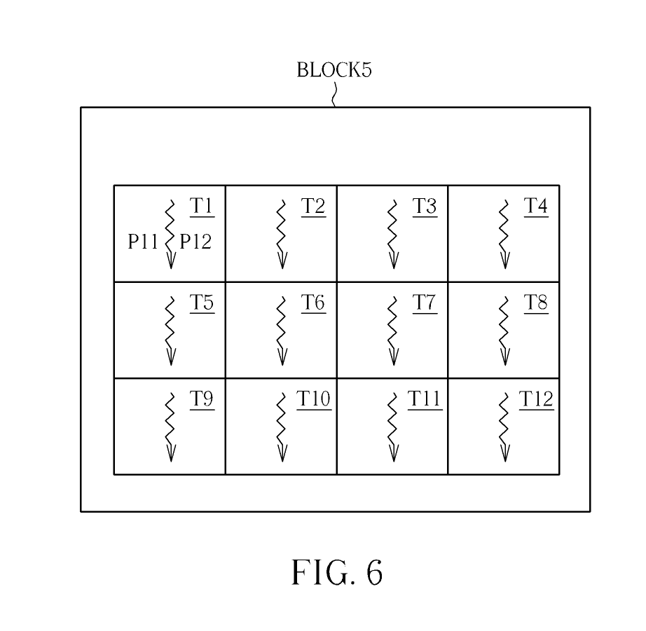

Please refer to FIG. 5 and FIG. 6. FIG. 5 is a diagram illustrating an image grid 408 after the processor 404 divides the image data with the predetermined format into the plurality of parallel processing data groups, and FIG. 6 is a diagram illustrating an image block BLOCK5 including a plurality of execution threads. The processor 404 can divide image data with the predetermined format corresponding to a predetermined number of consecutive frames into a plurality of image grids, divide each image grid of the plurality of image grids into a plurality of image blocks (such as 6 image blocks), and divide each image block of the plurality of image blocks into a plurality of execution threads (such as 12 execution threads), where the predetermined number of consecutive frames can be determined by performance of the processor 404 and a designer of the device 400. For example, the predetermined number of consecutive frames can be 16 consecutive frames. But, the present invention is not limited to the 16 consecutive frames. In addition, the present invention is also not limited to each image grid including 6 image blocks, and each image block including 12 execution threads. As shown in FIG. 5, the image grid 408 includes a plurality of image blocks (such as 6 image blocks BLOCK1-BLOCK6), and as shown in FIG. 6, the image block BLOCK5 includes a plurality of execution threads (such as 12 execution threads T1-T12). Therefore, multiple cores within the processor 404 can calculate and output colors corresponding to a plurality of pixels (such as 2 pixels) corresponding to each execution thread of the plurality of execution threads simultaneously, and calculate and output locations corresponding to a plurality of pixels corresponding to each execution thread of a plurality of execution threads to the display panel 406. For example, when 2 pixels P11, P12 corresponding to the execution thread T1 belong to a left eye image of the three-dimensional image corresponding to the three-dimensional image signal IS, the processor 404 can calculate locations L1, L2 (as shown in FIG. 4) on the display panel 406 corresponding to the 2 pixels P11, P12, so the display panel 406 can display colors corresponding to the 2 pixels P11, P12 at the locations L1, L2. But, the present invention is not limited to the 2 pixels P11, P12 belonging to the left eye image of the three-dimensional image corresponding to the three-dimensional image signal IS, and the present invention is also not limited to each execution thread only corresponding to 2 pixels. Thus, the display panel 406 can display a right eye image and a left eye image of the three-dimensional image corresponding to the three-dimensional image signal IS in the same frame simultaneously. Because the processor 404 can calculate colors corresponding to a plurality of pixels corresponding to each execution thread of a plurality of execution threads simultaneously, and calculate locations corresponding to a plurality of pixels corresponding to each execution thread of a plurality of execution threads simultaneously, the display panel 406 can display the three-dimensional image corresponding to the three-dimensional image signal IS according to colors and locations corresponding to a plurality of pixels corresponding to each execution thread of a plurality of execution threads. In addition, colors corresponding to a plurality of pixels corresponding to each execution thread can be colors with an RGB format or colors with a YUV format according to a type of the display panel 406. But, the present invention is not limited to colors corresponding to a plurality of pixels corresponding to each execution thread being colors with the RGB format or colors with the YUV format. In addition, subsequent operational principles of other image blocks of the 6 image blocks BLOCK1-BLOCK6 are the same as those of the image block BLOCK5, so further description thereof is omitted for simplicity, and subsequent operational principles of other image grids of the plurality of image grids are the same as those of the image grid 408, so further description thereof is also omitted for simplicity.

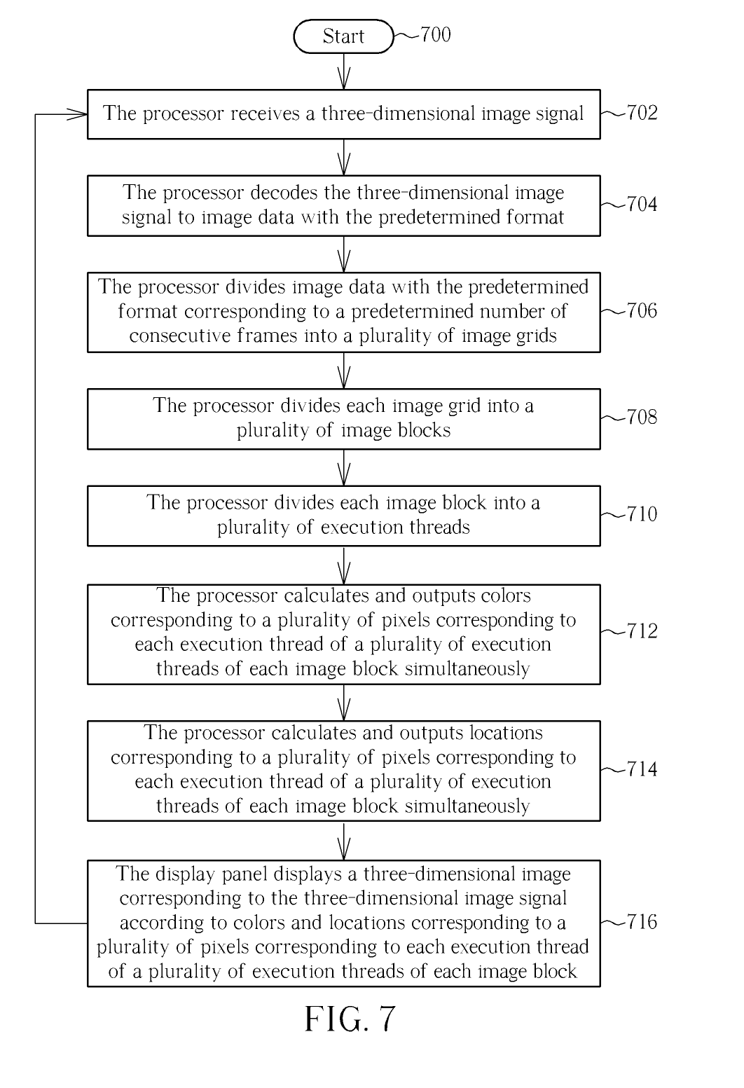

Please refer to FIG. 7, FIG. 4, FIG. 5, and FIG. 6. FIG. 7 is a flowchart illustrating a method for displaying three-dimensional images according to another embodiment. The method in FIG. 7 is illustrated using the device 400 in FIG. 4. Detailed steps are as follows:

Step 700: Start.

Step 702: The processor 404 receives a three-dimensional image signal IS.

Step 704: The processor 404 decodes the three-dimensional image signal IS to image data with the predetermined format.

Step 706: The processor 404 divides image data with the predetermined format corresponding to a predetermined number of consecutive frames into a plurality of image grids.

Step 708: The processor 404 divides each image grid into a plurality of image blocks.

Step 710: The processor 404 divides each image block into a plurality of execution threads.

Step 712: The processor 404 calculates and outputs colors corresponding to a plurality of pixels corresponding to each execution thread of a plurality of execution threads of each image block simultaneously.

Step 714: The processor 404 calculates and outputs locations corresponding to a plurality of pixels corresponding to each execution thread of a plurality of execution threads of each image block simultaneously.

Step 716: The display panel 406 displays a three-dimensional image corresponding to the three-dimensional image signal IS according to colors and locations corresponding to a plurality of pixels corresponding to each execution thread of a plurality of execution threads of each image block; go to Step 702.

In Step 704, the predetermined format can be the NV12 format. In Step 706, the predetermined number of consecutive frames can be determined by performance of the processor 404 and the designer of the device 400. In Step 712 and Step 714, the multiple cores within the processor 404 can calculate and output colors corresponding to a plurality of pixels (such as 2 pixels) corresponding to each execution thread of a plurality of execution threads (such as 12 execution threads) simultaneously, and calculate and output locations corresponding to a plurality of pixels corresponding to each execution thread of a plurality of execution threads, where colors corresponding to a plurality of pixels corresponding to each execution thread can be colors with an RGB format or colors with a YUV format according to a type of the display panel 406. In addition, the present invention is not limited to each execution thread only corresponding to 2 pixels. In Step 716, the display panel 406 can display a right eye image and a left eye image of a three-dimensional image corresponding to the three-dimensional image signal IS in the same frame simultaneously according to colors and locations corresponding to a plurality of pixels corresponding to each execution thread of a plurality of execution threads of each image block. That is to say, the display panel 406 can display the three-dimensional image corresponding to the three-dimensional image signal IS according to colors and locations corresponding to a plurality of pixels corresponding to each execution thread of a plurality of execution threads of each image block.

To sum up, the device for displaying three-dimensional images and the method for displaying three-dimensional images utilize the processor to decode a three-dimensional image signal to image data with the predetermined format, utilize the processor to divide the image data with the predetermined format into a plurality of parallel processing data groups, and utilize the multiple cores of the processor to execute image processing on the plurality of parallel processing data groups simultaneously. Then, the display panel can display a three-dimensional image corresponding to the three-dimensional image signal according to image processing results of the plurality of parallel processing data groups. Compared to the prior art, because the present invention utilizes the multiple cores of the processor to execute image processing on the plurality of parallel processing data groups simultaneously, the present invention does not occupy most resources of the device for displaying three-dimensional images.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for displaying three-dimensional images, the method comprising:
receiving a three-dimensional image signal;
decoding the three-dimensional image signal to image data with a predetermined format;
dividing the image data with the predetermined format into a plurality of parallel processing data groups;
executing image processing on the plurality of parallel processing data groups simultaneously; and
displaying a three-dimensional image corresponding to the three-dimensional image signal according to image processing results of the plurality of parallel processing data groups.

2. The method of claim 1, wherein dividing the image data with the predetermined format into the plurality of parallel processing data groups further comprises:
dividing the image data with the predetermined format corresponding to a predetermined number of consecutive frames into a plurality of image grids;
dividing each image grid of the plurality of image grids into a plurality of image blocks; and
dividing each image block of the plurality of image blocks into a plurality of execution threads.

3. The method of claim 2, wherein executing the image processing on the plurality of parallel processing data groups simultaneously further comprises:
calculating and outputting colors corresponding to a plurality of pixels corresponding to each execution thread of each image block of each image grid of the plurality of image grids simultaneously; and
calculating and outputting locations corresponding to the plurality of pixels corresponding to the execution thread of the image block of the image grid of the plurality of image grids simultaneously.

4. The method of claim 3, wherein displaying the three-dimensional image corresponding to the three-dimensional image signal according to the image processing results of the plurality of parallel processing data groups further comprises:
displaying the three-dimensional image corresponding to the three-dimensional image signal according to the colors and the locations corresponding to the plurality of pixels corresponding to the execution thread of the image block of the image grid of the plurality of image grids.

5. The method of claim 3, wherein the colors corresponding to the plurality of pixels corresponding to the execution thread are colors with an RGB format.

6. The method of claim 3, wherein the colors corresponding to the plurality of pixels corresponding to the execution thread are colors with a YUV format.

7. The method of claim 2, wherein each execution thread of the plurality of execution thread corresponds to two pixels.

8. The method of claim 1, wherein displaying the three-dimensional image corresponding to the three-dimensional image signal is a Liquid Crystal Retarder three-dimensional (LC Retarder 3D) panel displaying the three-dimensional image corresponding to the three-dimensional image signal.

9. The method of claim 1, wherein displaying the three-dimensional image corresponding to the three-dimensional image signal is an autostereoscopy three-dimensional panel displaying the three-dimensional image corresponding to the three-dimensional image signal.

10. A device for displaying three-dimensional images, the device comprising:
a processor for receiving a three-dimensional image signal, decoding the three-dimensional image signal to image data with a predetermined format, dividing the image data with the predetermined format into a plurality of parallel processing data groups, and executing image processing on the plurality of parallel processing data groups simultaneously; and
a display panel for displaying a three-dimensional image corresponding to the three-dimensional image signal according to image processing results of the plurality of parallel processing data groups.

11. The device of claim 10, wherein the processor dividing the image data with the predetermined format into the plurality of parallel processing data groups comprises:
the processor dividing the image data with the predetermined format corresponding to a predetermined number of consecutive frames into a plurality of image grids, dividing each image grid of the plurality of image grids into a plurality of image blocks, and dividing each image block of the plurality of image blocks into a plurality of execution threads.

12. The device of claim 11, wherein the processor executing the image processing on the plurality of parallel processing data groups simultaneously comprises:
the processor calculating and outputting colors corresponding to a plurality of pixels corresponding to each execution thread of each image block of each image grid of the plurality of image grids simultaneously, and calculating and outputting locations corresponding to the plurality of pixels corresponding to the execution thread of the image block of the image grid of the plurality of image grids simultaneously.

13. The device of claim 12, wherein the display panel displaying the three-dimensional image corresponding to the three-dimensional image signal according to the image processing results of the plurality of parallel processing data groups comprises:
the display panel displaying the three-dimensional image corresponding to the three-dimensional image signal according to the colors and the locations corresponding to the plurality of pixels corresponding to the execution thread of the image block of the image grid of the plurality of image grids.

14. The device of claim 12, wherein the colors corresponding to the plurality of pixels corresponding to the execution thread are colors with an RGB format.

15. The device of claim 12, wherein the colors corresponding to the plurality of pixels corresponding to the execution thread are colors with a YUV format.

16. The device of claim 11, wherein each execution thread of the plurality of execution threads corresponds to two pixels.

17. The device of claim 10, wherein the display panel is a Liquid Crystal Retarder three-dimensional panel.

18. The device of claim 10, wherein the display panel is an autostereoscopy three-dimensional panel.
